(19) United States
(12) Patent Application Publication
(10) Pub. No.: US 2006/0053667 A1
(43) Pub. Date: Mar. 16, 2006

(54) Vehicle flag holder

(76) Inventor: Gregory F. Andersen, Long Branch, NJ (US)

Correspondence Address: LITMAN LAW OFFICES, LTD, PO BOX 15035, CRYSTAL CITY STATION, ARLINGTON, VA, 22215, US

(21) Appl. No.: 11/266,243

(22) Filed: Nov. 4, 2005

Related U.S. Application Data
(63) Continuation-in-part of application No. 10/716,428, filed on Nov. 20, 2003, now abandoned.

(51) Int. Cl. G09F 21/04; B60R 9/00

(52) U.S. Cl. 40/591; 224/521

(57) ABSTRACT

The vehicle flag holder for mounting to a hitch receiver of a vehicle having a flagpole receiver has a tongue mount portion and a pole-receiving portion. The tongue mount portion is received by the vehicle hitch receiver and pole-receiving portion is attached to the tongue mount portion. The pole receiving portion includes a vertical section having aligned pivot pin receiving bores, upright positioning bores, and a horizontally mounted locking pin receiving flange having a locking pin bore therethrough. A flagpole extends from the pole-receiving portion and includes pivot pin through-bores, pole positioning through-bores, and a beveled angle bottom for abutting the pole-receiving portion when pivoted in a rearward direction. The flagpole also includes a spring-biased locking pin assembly mounted that locks the flagpole in a vertical position when a spring biased locking pin engages the locking pin bore of the locking pin receiving flange.

### CROSS-REFERENCE TO RELATED APPLICATIONS

This is a continuation-in-part of my prior application Ser. No. 10/716,428, filed Nov. 20, 2003.

### BACKGROUND OF THE INVENTION

1. Field of the Invention

The present invention relates to flag holders. More particularly, the present invention relates to a flag holder for a vehicle attachable to a hitch receiver.

2. Description of the Related Art

The display of flags mounted on vehicles is well known. Such flags are typically mounted on a front fender by means of a bracket and are limited to a relatively small size. These flags typically indicate that a dignitary is riding inside the vehicle. Many patriotic persons, particularly during wartime, would like to display a larger flag of their country than is supportable on a typical flag-mounting bracket for fenders. It would be desirable to provide a mounting for flags to be placed on a vehicle which may safely support a relatively large flagpole and flag. It would also be desirable to provide a mounting which may readily be removed from the vehicle. Such a support would desirably fit within a conventional hitch receiver which is typically centrally mounted below the rear bumper of a vehicle. It would be desirable, in addition, to provide a support which allows easy access to a rear door or tailgate of a vehicle without removing the flagpole mounted on the vehicle.

U.S. Patent Publication No. 2003/0094473 A1, published May 22, 2003, for Moore, describes a flagpole holder for mounting in a hitch receiver of a vehicle.

U.S. Patent Publication No. 2003/0071185 A1, published Apr. 17, 2003, for Casapulla, describes a flagpole holder for a trailer hitch receiver of a vehicle and also includes a ball type hitch which can be used with the flagpole holder in place.

U.S. Pat. No. 5,449,101, issued Sep. 12, 1995, to Van Dusen, describes a hitch receiver mounted rack which is adjustable between an upright position and a rearwardly angled position to allow access to a vehicle door or tailgate.

U.S. Pat. No. 5,775,560, issued Jul. 7, 1998, to Zahn et al., describes a hitch receiver mounted carrying apparatus which is adjustable between an upright position and a rearwardly angled position.

U.S. Pat. No. 5,626,126, issued May 6, 1997, to McNulty, describes a hitch receiver mounted barbeque rack where the post holding the grill may be folded out at about a 45-degree rearward angle relative to the vehicle for use.

U.S. Pat. No. 6,062,451, issued May 16, 2000, to Lassanske et al., describes a hitch receiver mounted bicycle rack which is adjustable from vertical to a rearward angle.

None of the above inventions and patents, taken either singly or in combination, is seen to describe the instant invention as claimed. Thus a vehicle flag holder solving the aforementioned problems is desired.

### SUMMARY OF THE INVENTION

The vehicle flag holder of the present invention is constructed to be fastened to the rear of a vehicle, inserted into a conventional hitch receiver or to a bumper hitch mount, depending upon how the vehicle is equipped. The flag receiver includes a rectangular tongue insert portion which may be inserted and secured within the hitch receiver in a conventional manner, similar to the insertion of a ball hitch and tongue. Attached to the rear of the tongue insert is an upward opening flagpole receiver portion having vertical sidewalls and a rear wall extending at an upward, rearward angle relative to vertical.

The sidewalls support a hinge pin which extends through a bore in a flagpole near its lower end such that the pole may be rotated forward and back, the backward travel being limited by the angled back wall to about 45 degrees rotation from vertical. The sidewalls also support a removable snap lock securing pin by a first pair of corresponding bores spaced vertically upward from the hinge pin and which extends through a bore in the flagpole spaced upward from the hinge pin bore, the flagpole being secured in a vertical position for display when the snap lock pin is inserted.

The sidewalls may also support the removable snap lock securing pin by a second pair of corresponding bores spaced to the rear of the first pair of bores, the second pair of bores being so located that the flagpole is secured at an upward, rearward angle of about 45 degrees from vertical such that when the flagpole is rotated toward the rear to rest against the angled rear wall of the pole receiver portion, the flagpole may be secured in place by the snap lock securing pin. The pole is secured in this position to allow the rear door or tailgate of the vehicle to swing to the open position without interference with the flagpole.

A vertical bore is provided in the tongue insert near its front end for fastening to a bumper hitch mount by means of a hitch bolt. This arrangement takes advantage of a bumper hitch mount vertical bore by which a ball hitch is normally mounted.

Another embodiment provides a cross beam centrally attached to the tongue insert as inserted into a hitch receiver, the crossbeam extending laterally along the bumper of the vehicle. Separate flagpole receivers as described above may be attached at opposite ends of the cross beam to support a total of two flagpoles for displaying two flags from the vehicle.

Accordingly, it is a principal object of the invention to provide a mounting or holder for securely holding a flagpole and flag of substantial size by a vehicle for flag display during driving or parking of the vehicle.

It is another object of the invention to provide a holder as above which employs an existing hitch system mounted on the vehicle.

It is a further object of the invention to provide a holder as above which may be rotated back and away from vertical and secured to display the flag at an angle and allow for opening of a vehicle rear door or tail gate.

Still another object of the invention is to provide a holder as above which may securely hold two flagpoles for display of two flags.

It is an object of the invention to provide improved elements and arrangements thereof for the purposes described which is inexpensive, dependable and fully effective in accomplishing its intended purposes.

An alternative embodiment of a vehicle flag holder for mounting to a hitch receiver of a vehicle includes at least one flagpole receiver having a tongue mount portion and a first pole receiving portion. The tongue mount portion has such a cross section as to be received by the vehicle hitch receiver and removably secured thereon, the tongue mount portion having a distal end and a proximate end, the distal end being receivable by the vehicle hitch receiver.

The first pole-receiving portion is attached to and extends vertically from the proximate end of the tongue mount portion. The first pole receiving portion includes opposed, vertical sidewalls defining corresponding aligned pivot pin receiving bores located at respective lower portions thereof and further defining corresponding respective upright positioning bores located at respective upper portions thereof, which are vertically spaced from the pivot pin receiving bores. In addition, the first pole receiving portion includes a horizontally mounted locking pin receiving flange extending outwardly from an upper peripheral end of the first pole receiving portion and having a locking pin bore therethrough.

A first elongated flagpole extending upwardly from the first pole receiving portion has a lower end portion defining oppositely disposed pivot pin through-bores and oppositely disposed pole-positioning through-bores spaced upward from the pivot pin through-bores. A distal end of the lower end portion has a beveled angle for abutting a lower portion of the first pole-receiving portion when the first flagpole is pivoted in a rearward direction. Finally, a spring-biased locking pin assembly is mounted upward from the pole positioning through-bores, the spring biased locking assembly secures the first flagpole to the at least one first flagpole receiver in a vertical position when a spring-biased locking pin engages the locking pin bore of the locking pin receiving flange.

A pivot pin extends through the pivot pin receiving bores and the pivot pin through-bores for rearward pivotal mounting of the first flagpole to the first pole-receiving portion. A securing pin is removably mounted in and extends through the upright positioning bores and the pole positioning through-bores.

Another alternative embodiment of the invention contemplates at least a second pole receiver portion, wherein the tongue mount portion now includes a single inner tongue portion, two outer tongue portions, and a crossbeam having opposing ends and extending laterally along the rear of the vehicle, the crossbeam having a central point attached to the single inner tongue portion. The two outer tongue portions are attached to and extend rearwardly from the opposing ends of the crossbeam.

The vehicle flag holder in this alternative embodiment further comprises a second pole receiving portion, the first pole receiving portion being attached to and extending rearward from one of the outer tongue portions, the second pole receiving portion being attached to and extending rearward of the other of the outer tongue portions, wherein the first and a second flagpoles are removably and pivotally mounted in the first and second pole receiving portions, respectively.

These and other objects of the present invention will become readily apparent upon further review of the following specification and drawings.

### BRIEF DESCRIPTION OF THE DRAWINGS

FIG. 1 is an environmental, perspective view of a vehicle flag holder according to the present invention.

FIG. 2 is a detail view of the vehicle flag holder of FIG. 1.

FIG. 3 is an exploded view of the vehicle flag holder of FIG. 1.

FIG. 4 is depiction of a prior art bumper hitch mount and ball hitch.

FIG. 5 is a detail view of the vehicle flag holder of FIG. 1 as mounted on a bumper hitch mount as in FIG. 4.

FIG. 6 is an environmental, perspective view of another embodiment of the inventive flag holder wherein two flag receivers as in FIG. 1 are supported by the flag holder.

FIG. 7 is a detail view of the embodiment of FIG. 6.

FIG. 8 is an environmental, perspective view of an alternative embodiment of a vehicle flag holder in an open position according to the present invention.

FIG. 9 is an environmental, perspective view of an alternative embodiment of a vehicle flag holder according to the present invention in a closed position.

FIG. 10 is a side view of the alternative embodiment of the vehicle flag holder in a closed position according to the present invention.

FIG. 11 is a side view of the alternative embodiment of the vehicle flag holder in an open position.

FIG. 12 is an environmental, perspective view of an additional alternative embodiment of a flag holder having the capacity of carrying multiple flags.

Similar reference characters denote corresponding features consistently throughout the attached drawings.

### DETAILED DESCRIPTION OF THE PREFERRED EMBODIMENTS

The present invention is a vehicle mounted flag holder constructed to be fastened to the rear of a vehicle, inserted into a conventional hitch receiver or to a bumper hitch mount, depending upon how the vehicle is equipped. The vehicle may be any type of a motor vehicle having an appropriate receiver hitch, including automobiles, trucks, motorcycles, etc. The flag holder has a provision for securely supporting a flagpole in a vertical position for display of a flag of substantial size while the vehicle is in motion or parked. The flag holder also has provision for rotating and securing the flagpole rearwardly to allow opening of a vehicle rear door or tailgate. Another embodiment supports two flagpoles, each displaying a flag.

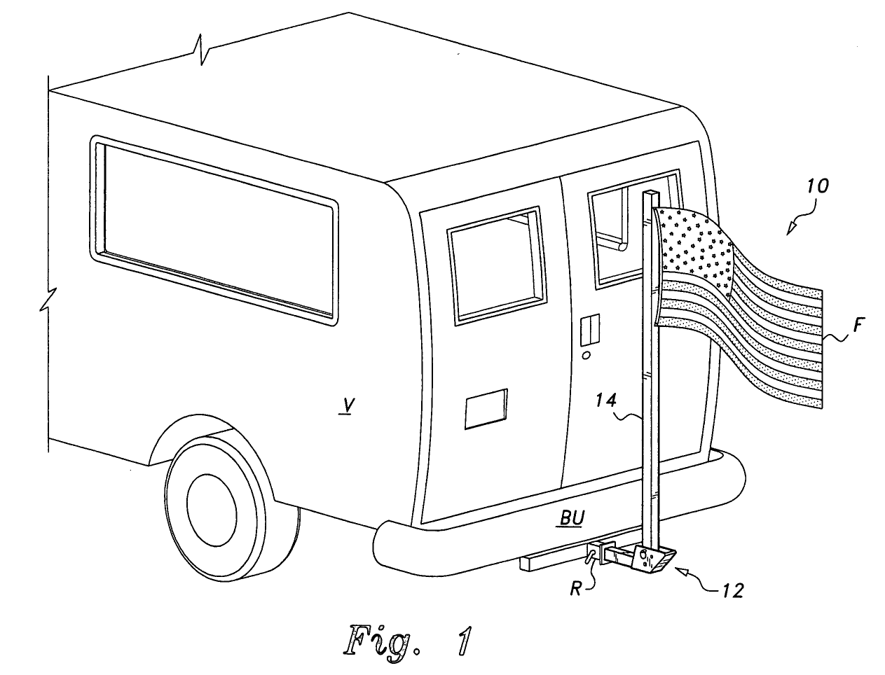

Referring to FIG. 1, there is shown an environmental, perspective view of a first embodiment of the invention as mounted to a recreational vehicle having a conventional hitch receiver. Flag holder system 10 is mounted on vehicle V having rear bumper BU and hitch receiver R wherein flagpole receiver 12 supports flagpole 14 in a vertical position for displaying flag F.

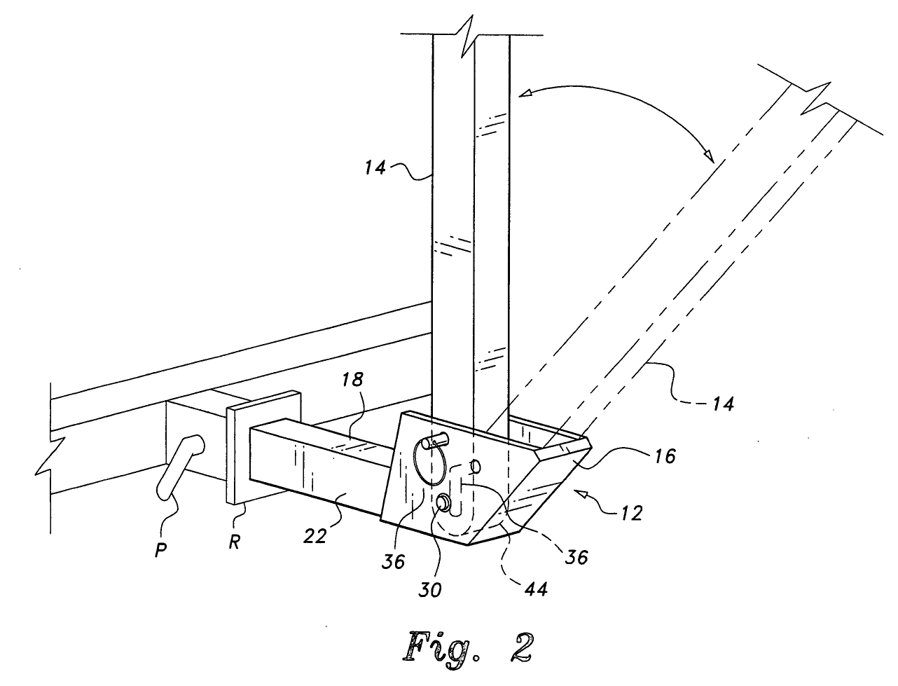

Referring to FIGS. 2-5, there are shown detail and exploded views of the inventive flag holder system 10 of FIG. 1 wherein flagpole receiver 12 supports flagpole 14 in upward opening pole receiving portion 16 connected with tongue insert portion 18 which is inserted into hitch receiver R. Flagpole receiver 12 is inserted and removably secured in hitch receiver R by receiver pin P inserted through the sidewalls of receiver R and tongue receiver pin bores 20 extending through sidewalls 22 of tongue insert portion 18, pin P being secured by clip C. Tongue insert portion 18 has a distal end for insertion within receiver hitch receiver R and a rear proximate end to which receiver 16 is mounted.

Receiver 16 has opposed sidewalls 24 attached to the proximate end of tongue insert portion 18, as by welding, between which is mounted angled end wall 26 forming the rear end of the flagpole receiver 12. End wall 26 is angled upward and rearward relative to the vehicle V, preferably at an angle of about 45 degrees relative to the vertical. Side walls 24 have laterally aligned pivot pin receiving bores 28 located in their lower portion bore receiving pivot pin 30 secured by clip 32 against washer 34. Side walls 24 have laterally aligned upright positioning bores 38 located in their upper portions and spaced vertically above pivot pin receiving bores 28 for receiving snap lock securing pin 36 having detent 37. Sidewalls 24 have laterally aligned angled positioning bores 40 spaced rearwardly from upright positioning bores 38. Flagpole 14 has sides 42 and a rounded end 44 through which a lateral pole pivot through-bore 28 extends. A lateral pole positioning through-bore 48 is axially spaced upward from through-bore 44 and extends through pole 14 parallel with through-bore 44.

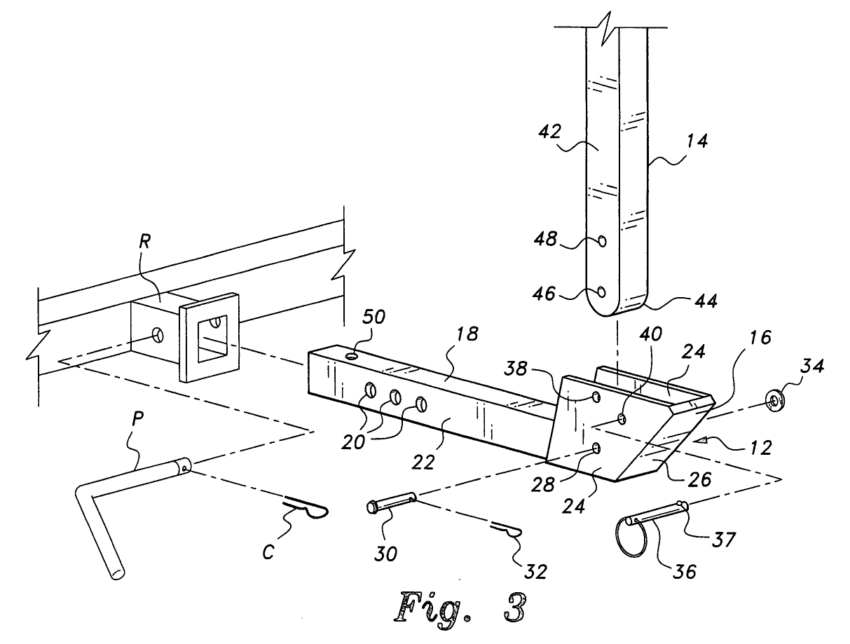

As best seen in FIGS. 2 and 3, flagpole 14 may be rotated from a secured vertical position to a secured angled position by pulling to remove snap lock securing pin 36 from upright position bores 38 in side walls 24 rotating flagpole 14 rearward around pivot pin 30 until it rests against end wall 16, and the inserting snap lock securing pin 36 through angled position bores 40 and pole position through-bore 48, thereby securing pole 14 in an angled position. The pole 14 may be returned to a vertical position by reversing these steps.

Referring more particularly to FIGS. 3, 4, and 5, vehicle V has a rear bumper BU having a centrally located bumper hitch mount H (shown as a flat portion of rear bumper BU). A bar type hitch mount H extending from under the vehicle in a conventional manner may be used as an equivalent mounting. A hitch ball B is normally secured through a vertical bore in the hitch mount and secured by a nut N under the mount as turned on the threaded mounting stud S. A vertical bumper mount bore 50 in tongue insert portion 18 of flagpole receiver 12 near its distal end allows flagpole receiver 12 to be mounted in place of hitch ball B by insertion of hitch mount bolt 52 downward through bumper mount bore 50 and securing in place by nut N. Preferably, washers are placed between the nut N and head of bolt 52 and the lower and upper surfaces of tongue insert portion 18.

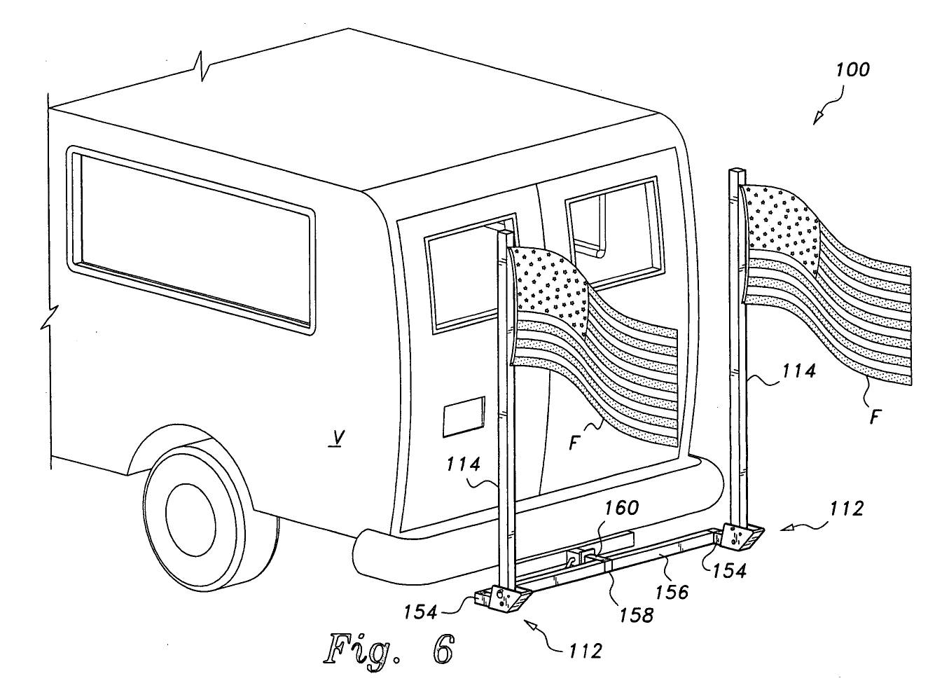

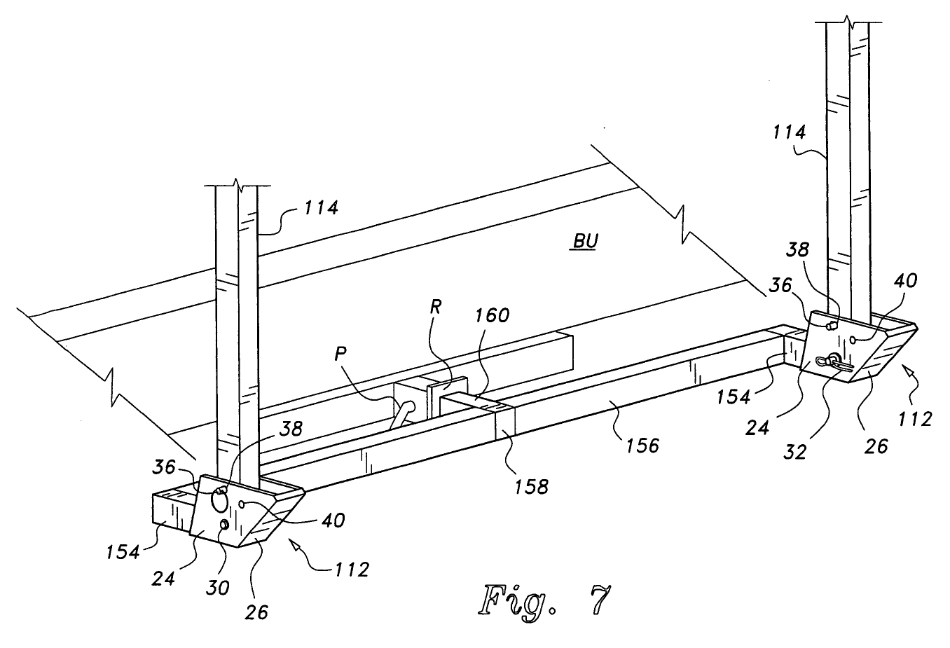

Referring to FIGS. 6 and 7 there is shown an environmental, perspective view and a detail view of another embodiment 100 of the invention where two flagpoles are supported by the vehicle V for displaying two flags F. In this embodiment two flagpole receivers 112 are connected by outer tongue portions 154 to opposing ends of a cross beam 156 extending laterally along the bumper BU of vehicle V. Cross beam 156 is supported at its center point 158 by inner tongue insert portion 160 which is removably inserted into hitch receiver R and secured by receiver pin P. Each flagpole 114 is rotatable and securable in a vertical position and a rearward angled position within the pole receiving portions of flagpole receivers 112 in an identical manner to that described above in which a single flagpole is supported in vertical and angled positions (see detailed description above relating to FIGS. 1-4). This embodiment has the advantage of providing clear vision back for the driver. Of course, any desired number of flag holders 112 may be mounted on cross beam 156 for displaying an equal number of flags on flagpoles 114 and such embodiments are within the scope of the claims. Also, cross beam 156 may be used to offset a single flag holder 112 to improve rear vision back for the driver.

The flag holders of the present invention are preferably constructed of steel or aluminum, however other appropriate materials may be employed in their construction. The flagpole and holder may be constructed to fit any existing commercial 1 1/4″ or 2″ receiver style type II, III, IV, or V trailer hitch. The receiver style hitch is made by manufacturers such as Reese, Draw-Tight, and Putnam. The flagpoles are preferably from about 4 to 6 feet in length and are made of graphite or fiberglass composite that allow the pole to flex in high winds. The flagpoles may have spring mount portion at their lower end as is known in the antennae arts to allow flexing in wind and avoid damage from collision. The flagpoles are preferably of such a length as to not extend above the cab of the vehicle to minimize collision with tree limbs or the like. The flagpoles may be adjustable in height such as by “telescoping” in a well-known manner to allow transfer between vehicles of different heights.

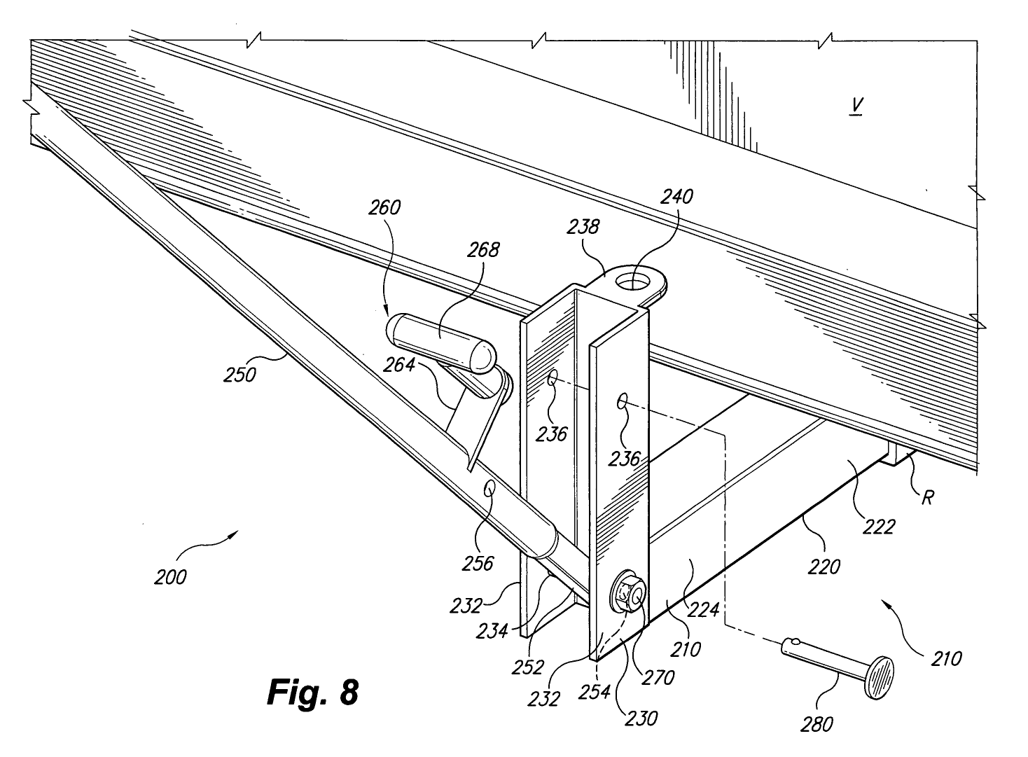

An alternative embodiment of the present invention is shown in FIGS. 8-11.

In the following alternative embodiment, a vehicle flag holder 200 mounts to a hitch receiver R of a vehicle V. A flagpole receiver 210 has a tongue mount portion 220 and a pole-receiving portion 230. The tongue mount portion 220 has a typical cross section to be received by the vehicle hitch receiver R and is removably secured thereon at a distal end 222. The pole-receiving portion 230 is attached to and extends vertically from a proximate end 224 of the tongue mount portion 220. The pole receiving portion 230 includes opposed and vertical sidewalls 232 that have corresponding aligned pivot pin receiving bores 234 located at respective lower portions thereof, and further defines corresponding respective upright positioning bores 236 located at respective upper portions thereof, which are vertically spaced from the pivot pin receiving bores 234. The pole-receiving portion 230 additionally includes a horizontally mounted locking pin receiving flange 238 extending outwardly from an upper peripheral end, the flange having a locking pin bore 240 defined therethrough.

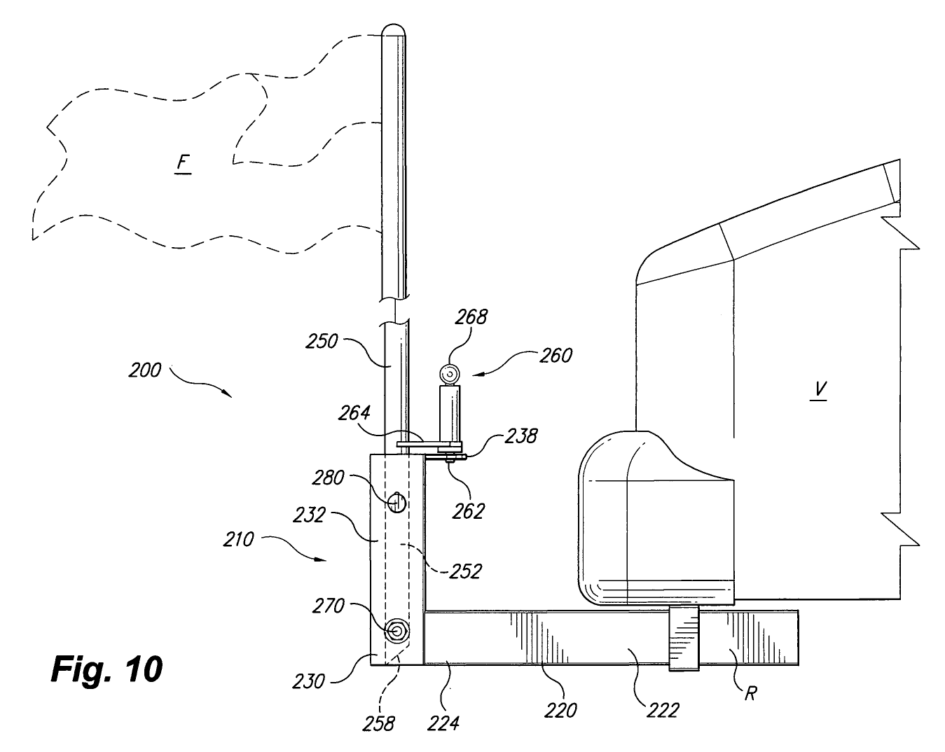

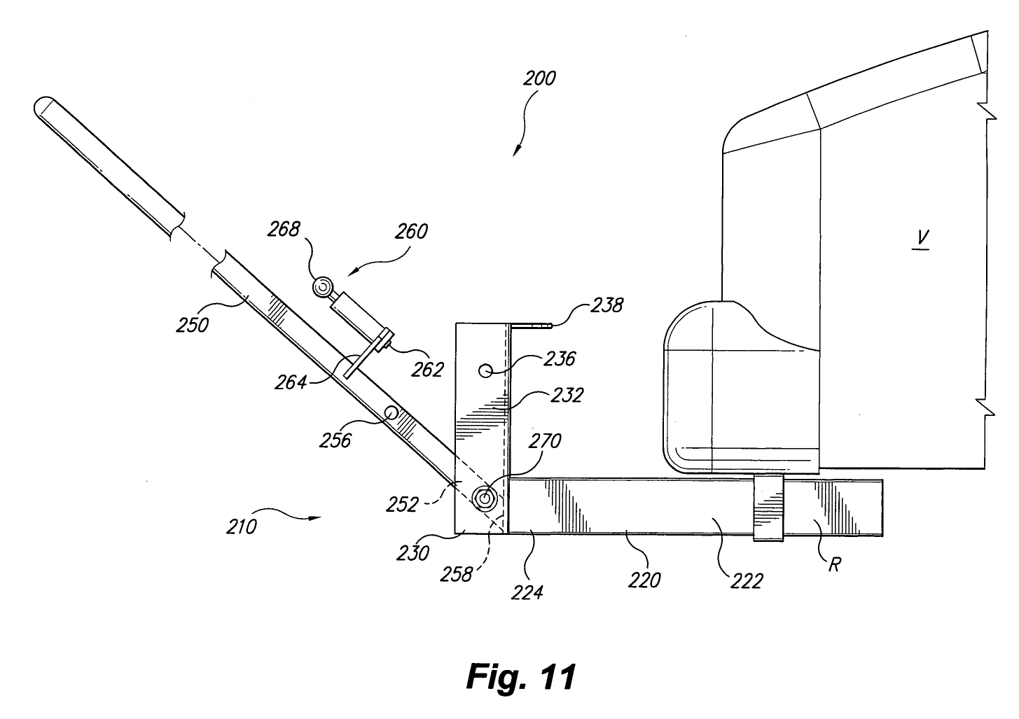

An elongated flagpole 250 extends upwardly from the pole-receiving portion 230, the flagpole being approximately four to six feet in length. The flagpole is able to receive a flag F, and has a lower end portion 252 including oppositely disposed pivot pin through-bores 254 and oppositely disposed pole-positioning through-bores 256 spaced upward from the pivot pin through-bores 254. At the distal end of the lower end portion 252, the flagpole has a beveled angle 258 for abutting a lower portion of the pole receiving portion 230 when the flagpole 250 is pivoted in a rearward direction, as shown in FIGS. 10 and 11. The flagpole 250 may be pivoted in a rearward direction between about 45° to 55° from vertical. Additionally, the flagpole 250 may be made of composite material to allow flexing in high winds.

The elongated flagpole 250 also includes a spring-biased locking pin assembly 260 mounted above the pole positioning through-bores 256. The locking assembly 260 locks the flagpole 250 into a fixed vertical position when a spring-biased locking pin 262 engages the locking pin bore 240 of the locking pin receiving flange 238.

A pivot pin 270 extends through the pivot pin receiving bores 234 and the pivot pin through-bores 254 for rearward pivotal mounting of the flagpole 250 to the pole-receiving portion 230. A securing pin 280 is removably mounted in, and extends through, the upright positioning bores 236 and the pole positioning through-bores 256 to affix the flagpole 250 to the pole-receiving portion 230. The securing pin 280 may be a snap lock pin (like pin 36, as shown in FIG. 3, having a detent 37).

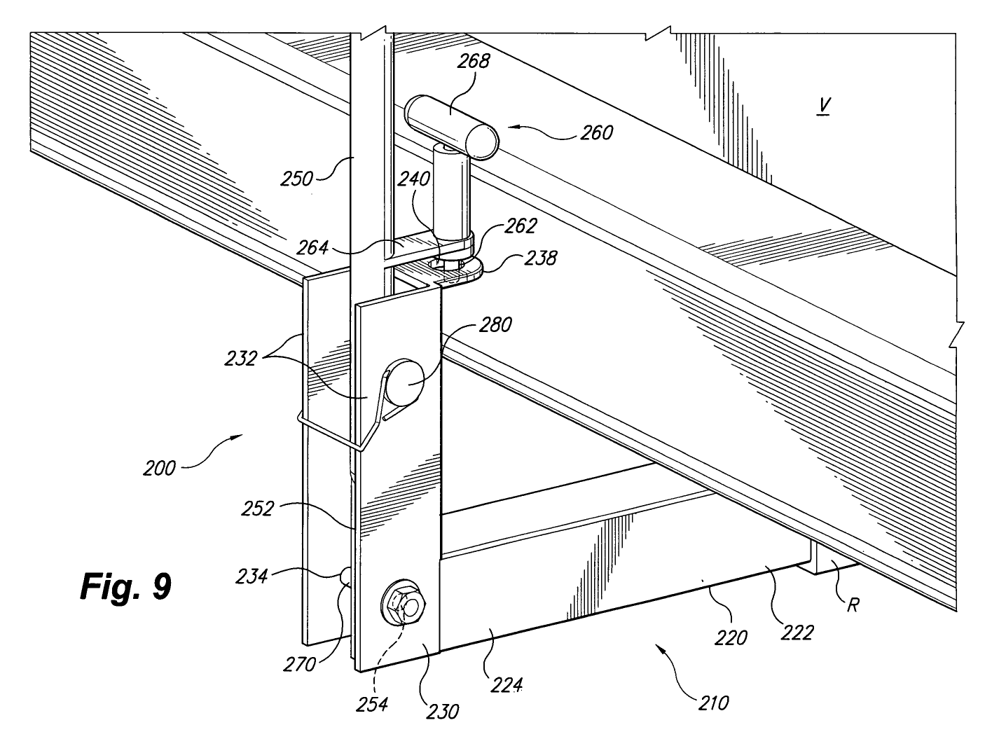

The spring-biased locking pin assembly 260 includes a locking pin mounting flange 264 that projects from an exterior surface of the flagpole 250 and has a locking pin through-bore. The spring biased locking pin 262 projects through the locking pin mounting flange 264, as shown in FIGS. 9 and 10. A handle 268 connects to the locking pin 262 to move the locking pin 262 against a spring force to a temporarily retracted position (as shown in FIG. 11), so that the locking assembly 260 locks the first flagpole 250 in a vertical position to the flagpole receiver 210 when the locking pin 262 engages the locking pin through-bore 240 of the locking pin receiving flange 238, as shown in FIGS. 9 and 10.

The tongue mount portion 220 of the flagpole receiver 210 is rectangular in cross section and is sized to slidingly fit within the vehicle hitch receiver R, and has at least one laterally extending receiving bore for removably receiving a receiver pin P (as shown in FIGS. 2-3) for removably securing the vehicle flag holder 200 to the vehicle hitch receiver R. The vehicle hitch receiver R of the alternative embodiment may be a type II, III, IV or V trailer hitch and the tongue mount portion 210 may be sized to slidably fit within each of these respective vehicle hitch receivers R.

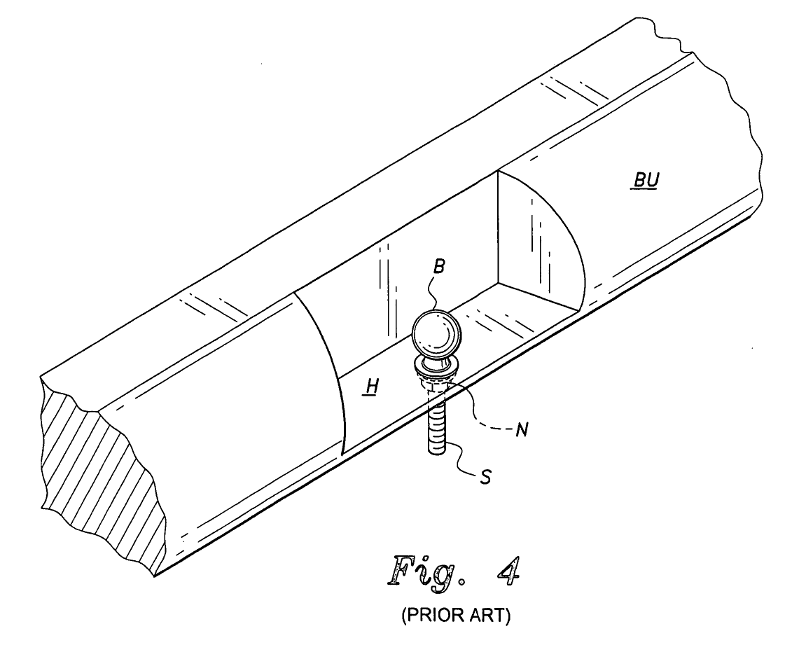

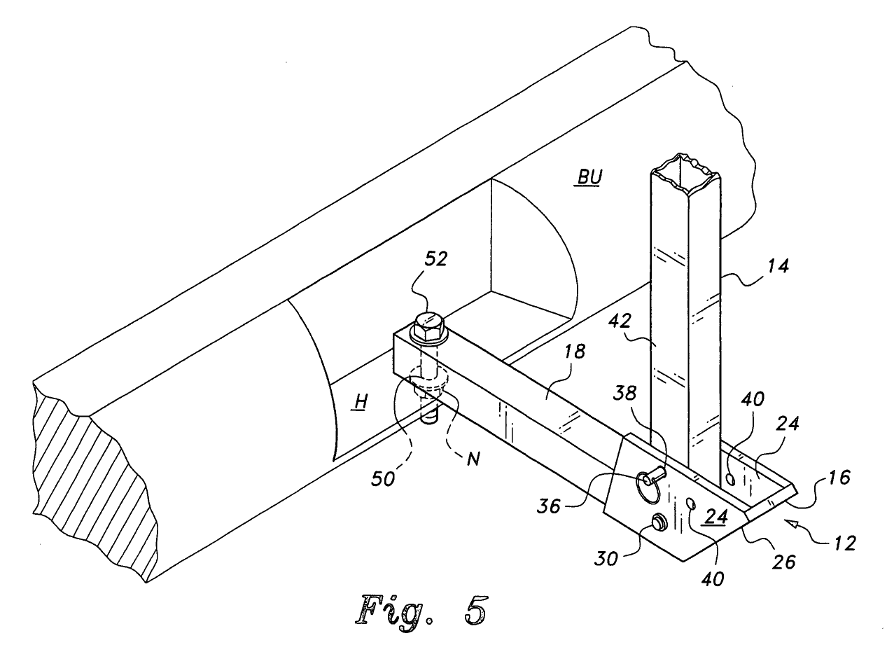

An alternative hitch attachment configuration may be adapted to include a vehicle V having a bumper hitch mount (H, as shown in FIG. 4) for mounting a hitch ball B. In this configuration, the tongue mount portion 210 may have a vertically oriented bumper mount bore (like 50, as shown in FIG. 5) spaced outward from the distal end, and further including a hitch mount bolt 52 (of FIG. 5) removably extending through the bumper mount bore 50 and the bumper hitch mount H of the vehicle V.

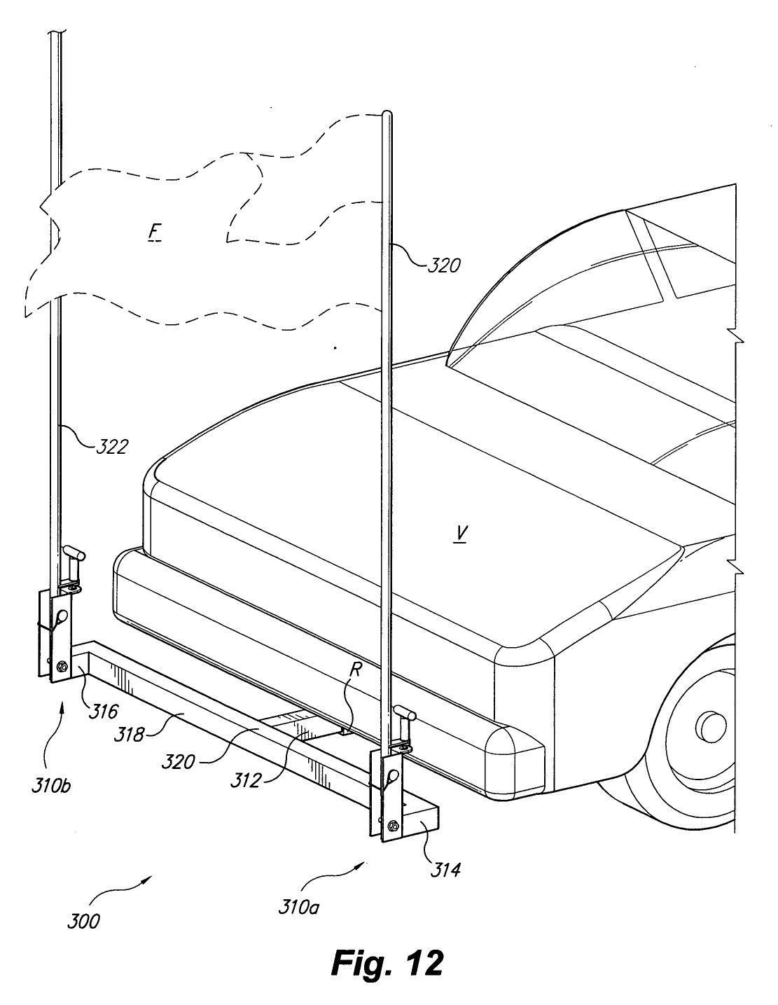

A second alternative embodiment of the present invention, shown in FIG. 12, is most similar to the modification of the original invention shown in FIGS. 6-7.

The vehicle flag holder 300 may have at least two pole receiving portions 310a and 310b. A newly configured tongue mount portion may include a single inner tongue portion 312 for slidably being received by a hitch receiver R, two outer tongue portions 314, 316 and a crossbeam 318 having opposing ends and extending laterally along the rear of the vehicle V. A central point 320 attaches to the single inner tongue portion 312. The two outer tongue portions 314, 316 may be attached to and extend rearwardly from the opposing ends of the crossbeam 318.

The pole receiving portion 310a may be attached to and extend rearward from one of the outer tongue portions 314, and the second pole receiving portion 310b may be attached to and extend rearward of the other of the outer tongue portions 316. First and second flagpoles 320 and 322, respectively, and flags F are removably and pivotally mounted in the first 310a and second 310b pole receiving portions.

This configuration may also support a plurality of the flagpole receivers located along the crossbeam 318, the receivers supporting an equal plurality of flagpoles. Each of the flagpoles 320, 322 may be made of composite material to allow flexing in high winds.

In addition, this alternative hitch attachment configuration may be adapted to include a vehicle V having a bumper hitch mount (H, as shown in FIG. 4) for mounting a hitch ball B. In this configuration, the tongue mount portion 210 may have a vertically oriented bumper mount bore (like 50, as shown in FIG. 5) spaced outward from the distal end, and further include a hitch mount bolt 52 (of FIG. 5) removably extending through the bumper mount bore 50 and the bumper hitch mount H of the vehicle V.

Any flag or combination thereof may be displayed by the present invention.

It is to be understood that the present invention is not limited to the embodiments described above, but encompasses any and all embodiments within the scope of the following claims.

I claim:

1. A vehicle flag holder for mounting to a hitch receiver of a vehicle, the flag holder comprising:
(a) at least one flagpole receiver having a tongue mount portion and a first pole receiving portion, the tongue mount portion being adapted for attachment to the vehicle hitch receiver, the said first pole receiving portion being attached to and extending vertically from the tongue mount portion, said first pole receiving portion including:
(i) opposed vertical sidewalls defining corresponding aligned pivot pin receiving bores located at respective lower portions thereof and corresponding respective upright positioning bores located at respective upper portions thereof vertically spaced from the pivot pin receiving bores; and
(ii) a horizontally mounted locking pin receiving flange extending outwardly from an upper peripheral end of the first pole-receiving portion, the flange having a locking pin bore defined therethrough;
(b) a first elongated flagpole extending upwardly from the first pole receiving portion, the first flagpole having:
(i) a lower end portion defining oppositely disposed pivot pin through-bores and oppositely disposed pole positioning through-bores spaced upward from said pivot pin through-bores, a distal end of said lower end portion having a beveled angle for abutting a lower portion of the first pole receiving portion when the first flagpole is pivoted in a rearward direction; and
(ii) a spring-biased locking pin assembly mounted upward from said pole positioning through-bores, the locking assembly securing the first flagpole in a vertical position to the at least one first flagpole receiver when a spring-biased locking pin engages the locking pin bore of the locking pin receiving flange;
(c) a pivot pin extending through the pivot pin receiving bores and the pivot pin through-bores for rearward pivotal mounting of the first flagpole to the first pole receiving portion; and
(d) a securing pin removably mounted in and extending through the upright positioning bores and the pole positioning through-bores.

2. The vehicle flag holder claim 1, wherein said spring-biased locking pin assembly further comprises:
a locking pin mounting flange projecting from a surface of said first flagpole, the flange having a locking pin through-bore defined therein, said spring-biased locking pin projecting through said locking pin mounting flange; and
a handle connected to said spring-biased locking pin for moving said spring-biased locking pin against a spring force to a temporarily retracted position.

3. The vehicle flag holder of claim 1, wherein said tongue mount portion of said at least one flagpole receiver is rectangular in cross section and of such size as to slidingly fit within the vehicle hitch receiver, said tongue mount portion defining at least one laterally extending receiving bore for removably receiving a receiver pin for removably securing said vehicle flag holder to said vehicle hitch receiver.

4. The vehicle flag holder of claim 1, wherein said first flagpole is pivoted in said rearward direction approximately between 45° to 55° degrees from vertical.

5. The vehicle flag holder of claim 1, wherein said securing pin is a snap lock securing pin having a detent.

6. The vehicle flag holder of claim 1, wherein said first flagpole is approximately four to six feet in length.

7. The vehicle flag holder of claim 1, wherein said tongue mount portion defines a vertically oriented bumper mount bore, the flag holder further comprising a hitch mount bolt removably extending through the bumper mount bore for attachment to a bumper hitch mount of the vehicle.

8. The vehicle flag holder of claim 1, further comprising a flag mounted on said first flagpole.

9. The vehicle flag holder of claim 1, wherein said flagpole is made of composite material to allow flexing in high winds.

10. The vehicle flag holder of claim 1, further comprising a second pole receiver portion, said tongue mount portion comprising a single inner tongue portion, two outer tongue portions and a crossbeam having opposing ends and extending laterally along the rear of the vehicle, the crossbeam having a central point attached to said single inner tongue portion, said two outer tongue portions being attached to and extending rearwardly from the opposing ends of said crossbeam, said first pole receiving portion being attached to and extending rearward from one of said outer tongue portions, said second pole receiving portion being attached to and extending rearward of the other of said outer tongue portions, said first flagpole and a second flagpole being removably and pivotally mounted in said first and second pole receiving portions, respectively.

11. The vehicle flag holder of claim 10, wherein said second flagpole is pivoted in said rearward direction approximately between 45° to 55° from vertical.

12. The vehicle flag holder of claim 10, wherein said at least one flag holder comprises a plurality of said flagpole receivers are located along said cross beam supporting an equal plurality of flagpoles.

13. The vehicle flag holder of claim 10, wherein said tongue mount portion defines a vertically oriented bumper mount bore, the flag holder further comprising a hitch mount bolt removably extending through the bumper mount bore for attachment to a bumper hitch mount of the vehicle.

14. The vehicle flag holder of claim 10, further comprising a flag mounted on each said flagpoles.

15. The vehicle flag holder of claim 10, wherein each of said flagpoles is made of composite material to allow flexing in high winds.
